(19) United States
(12) Patent Application Publication
(10) Pub. No.: US 2021/0331410 A1
(43) Pub. Date: Oct. 28, 2021

(54) ADDITIVE MANUFACTURING

(71) Applicant: HEWLETT-PACKARD DEVELOPMENT COMPANY, L.P., Spring, TX (US)

(72) Inventors: Arthur H Barnes, Vancouver, WA (US); Alejandro Manuel de Pena, Sant Cugat del Valles (ES); Sebastia Cortes I Herms, Sant Cugat del Valles (ES)

(21) Appl. No.: 16/607,802

(22) PCT Filed: Jun. 17, 2018
(86) PCT No.: PCT/US2018/037962

§ 371 Date: Oct. 24, 2019

(51) Int. Cl. B29C 64/393; B33Y 30/00; B33Y 50/02; B29C 64/295; B29C 64/264

(52) U.S. Cl. CPC B29C 64/393; B33Y 30/00; B33Y 10/00; B29C 64/295; B29C 64/264; B33Y 50/02

(57) ABSTRACT

In one example, a control process for additive manufacturing includes: forming an extent of unfused build material on a support; applying a coolant to unfused build material within the extent of unfused build material in a pattern of spots; capturing a thermal image of the extent of unfused build material with a thermal imaging device; mapping a pixel location in the thermal image to a physical location for each of multiple spots in the pattern; and based on the mapping, establishing a transform between pixels on the thermal imaging device and physical locations on the support.

### BACKGROUND

Additive manufacturing machines produce 3D (three-dimensional) objects by building up layers of material. Some additive manufacturing machines are commonly referred to as “3D printers.” 3D printers and other additive manufacturing machines convert a digital representation of an object into the physical object. The digital representation may be processed into slices each defining that part of a layer or layers of build material to be formed into the object.

### DRAWINGS

FIGS. 1-10 are a sequence of elevation and plan views illustrating one example of an additive manufacturing machine implementing a process for calibrating an infrared camera to a build platform.

FIGS. 11-20 are a sequence of plan views illustrating an additive manufacturing machine implementing one example of a manufacturing control process using temperature measurements from an infrared camera calibrated according to the process shown in FIGS. 1-10.

FIG. 21 illustrates one example a machine controller with programming to implement camera calibration and process control as shown in FIGS. 1-20.

FIG. 22 is a flow diagram illustrating one example of a process for calibrating an infrared camera or other thermal imaging device to the build platform in an additive manufacturing machine, such as the machine shown in FIGS. 1-20.

FIG. 23 is a flow diagram illustrating another example of a process for calibrating an infrared camera or other thermal imaging device to the build platform in an additive manufacturing machine, such as the machine shown in FIGS. 1-20.

FIG. 24 is a flow diagram illustrating one example of a control process for additive manufacturing using temperatures measured by a thermal imaging device that has been calibrated to the build platform.

FIG. 25 is a flow diagram illustrating another example of a control process for additive manufacturing using temperatures measured by a thermal imaging device that has been calibrated to the build platform.

The same part numbers designate the same or similar parts throughout the figures.

### DESCRIPTION

In some additive manufacturing machines, build material in each of many successive layers of build material is fused in a desired pattern to form an object layer by layer. Closely controlling the temperature of the build material during manufacturing improves the material properties, dimensions and appearance of the object.

A new technique has been developed to help more closely control build material temperatures during additive manufacturing. In one example, an infrared camera measures the temperature of build material in a designated reference area outside the build area. The reference area is positioned at a location where the temperature of the build material is the same as the temperature of build material in the build area during manufacturing. The temperature of build material in the reference area can then be used to represent the temperature of build material in the build area to control fusing energy. The location of the reference area is unchanged during manufacturing and, accordingly, the location of the reference area may be mapped to specific camera pixel or group of pixels to consistently and accurately monitor build material temperatures during manufacturing. Multiple reference areas may be used to measure the temperature of unfused and fused build material in each layer to control heating as well as fusing energy.

To accurately measure temperatures in a reference area, a pixel or group of pixels of the thermal imaging device should be correctly mapped to the physical location of the reference area. Mechanical tolerances in the parts and assemblies of an additive manufacturing machine may create variations in the relative position of the thermal imaging device and the build platform in different machines. Also, the manufacturing process itself may cause misalignment of the thermal imaging device and the build platform within a single machine. Consequently, it may be desirable to calibrate the thermal imaging device to the build platform before manufacturing and periodically during manufacturing to improve the accuracy of temperature measurements.

A new process has been developed to calibrate the thermal imaging device to the build platform. In one example, the process includes layering unfused build material on the platform, heating the unfused build material (before, during and/or after layering), and applying a detailing agent or other coolant to the heated, unfused build material in a predetermined pattern of spots. “Predetermined” in this context means each cool spot is formed at a known physical location on the platform in the layer of unfused build material. The thermal imaging device then captures an image of the spotted build material. The pixel location of each of multiple spots in the pattern is mapped to the physical location of the spot on the build platform to establish a transform between thermal imaging device pixels and physical locations on the build platform. Thus, the physical location of each reference area may be accurately mapped to the corresponding pixels of the thermal imaging device. The process may be implemented automatically through programming on the machine controller, for example at the beginning of each build cycle, to periodically calibrate the thermal imaging device without operator intervention.

These and other examples described herein illustrate but do not limit the scope of the patent, which is defined in the Claims following this Description.

As used in this document, “and/or” means one or more of the connected things; a “build area” means the area within which the primary objects are manufactured; a “fusing agent” means a substance that causes or helps cause a build material to sinter, melt, cure, bind, or otherwise fuse; a “detailing agent” means a substance that inhibits or prevents or enhances fusing a build material, for example by modifying the effect of a fusing agent and/or cooling the build material; and a “memory” means any non-transitory tangible medium that can embody, contain, store, or maintain information and instructions for use by a processor and may include, for example, circuits, integrated circuits, ASICs (application specific integrated circuits), hard drives, random access memory (RAM), read-only memory (ROM), and flash memory.

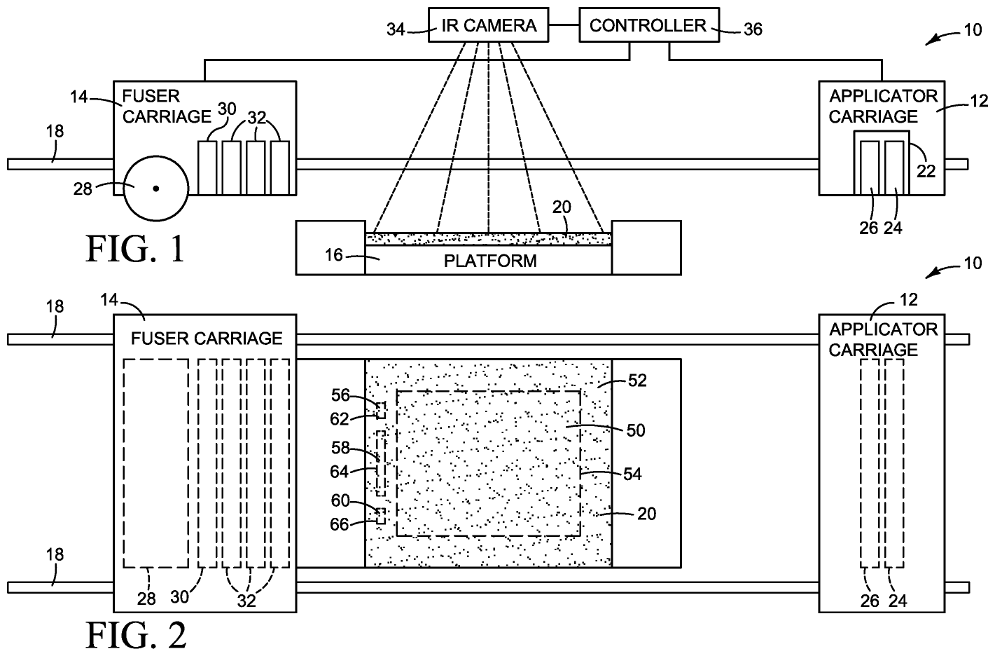

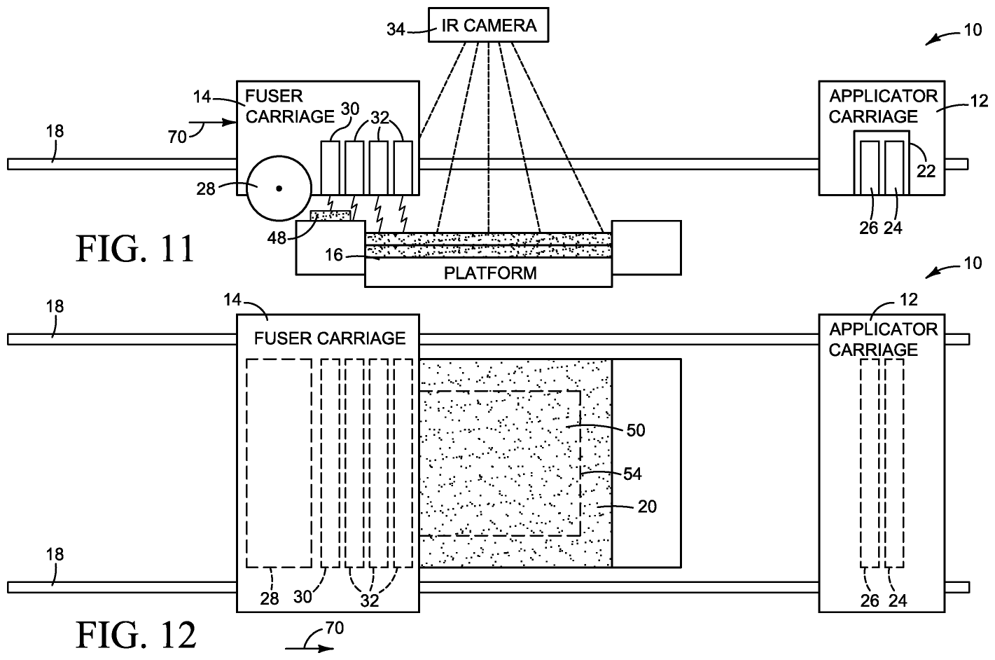

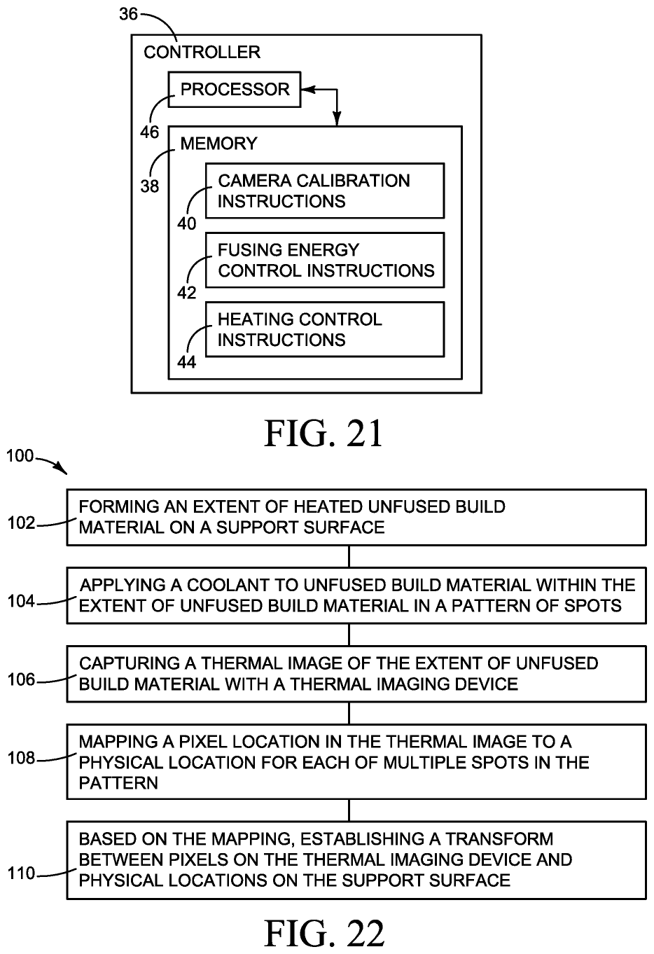

FIGS. 1-10 are a sequence of elevation and plan views illustrating one example of an additive manufacturing machine 10 implementing a process for calibrating an infrared camera to a build platform. FIGS. 11-20 illustrate machine 10 implementing one example of a manufacturing control process using temperature measurements from the calibrated camera. FIG. 21 illustrates one example a machine controller with programming to implement camera calibration and process control. Examples of camera calibration and process control are also described below with reference to the flow diagrams of FIGS. 22-25.

Referring to FIGS. 1 and 2, additive manufacturing machine 10 includes a first, “applicator” carriage 12 and a second, “fuser” carriage 14 that are moved back and forth over a build platform 16, for example on rails 18. Platform 16 provides a flat surface to support build material 20 during additive manufacturing. Unfused build material 20 is depicted by stippling in the figures. Applicator carriage 12 carries an inkjet printhead assembly or other suitable agent applicator 22 to apply a fusing agent to unfused build material 20. In the example shown, applicator 22 includes a first applicator 24 to apply a fusing agent and a second applicator 26 to apply another agent, for example a detailing agent.

Fuser carriage 14 carries a roller or other suitable layering device 28 to successively layer each of the many thin layers of build material 20 on to platform 16 for manufacturing an object. Only a few layers of build material are shown in the figures and the thickness of each layer is greatly exaggerated to better illustrate the examples shown and described. Hundreds or thousands of layers of build material a few tenths of a millimeter thick are commonly used in additive manufacturing to complete an object. Fuser carriage 14 also carries a heating lamp or other suitable heater 30 to heat unfused build material 20, and an array of fusing lamps or other suitable energy source 32 to apply fusing energy to unfused build material 20 treated with a fusing agent.

Machine 10 includes an infrared camera or other suitable thermal imaging device 34 positioned over platform 16 to measure build material temperatures. Machine 10 also includes a controller 36. Controller 36 represents the processing and memory resources, programming, and the electronic circuitry and components needed to control the operative components of machine 10, and may include distinct control elements for individual machine components. In particular, as shown in FIG. 21, controller 36 includes a memory 38 with camera calibration instructions 40, fusing energy control instructions 42, and heating control instructions 44, and a processor 46 to execute instructions 40, 42, and 44. Controller 36 is omitted from FIGS. 2-20 to not obstruct the view of other machine components.

A build area 50 is defined within the area encompassed by platform 16. In this example, build area 50 covers the central portion of the platform area and a non-build area 52 covers the boundary area surrounding build area 50. The perimeter 54 of build area 50 is indicated by dashed lines in FIG. 2. Perimeter 54 is not a structure on platform 16. Rather, perimeter 54 is a set of coordinates in a Cartesian or other coordinate machine defining the physical location of build area 50 on platform 16. As noted above, build area 50 is the area of platform 16 within which the primary objects are manufactured. Primary objects are not manufactured outside build area 50 where there may be less precise control of temperature and other process parameters that could adversely affect object quality.

Temperature measurements may be taken in reference areas inside and/or outside build area 50 to help calibrate and control manufacturing components and processes. In this example, reference areas 56, 58, and 60 are defined in boundary area 52 outside build area 50. The perimeter 62, 64, 66 of each reference area 56, 58, 60 is depicted by dashed lines in FIG. 2. In this example, reference areas 56, 58, 60 are all located along one side of build area 50. Usually it is desirable to position each reference area 56-60 at a location where the temperature of the build material is the same as, at a constant difference from, or otherwise corresponds uniformly to the temperature of build material in the build area during manufacturing. Thus, the temperature of build material in each reference area can then be used to accurately represent the temperature of build material in the build area to control fusing energy and other process parameters. In one example, the location of the reference areas remains unchanged during manufacturing and, accordingly, the location of each reference area may be mapped to specific camera pixels that also do not change during manufacturing. In another example, or one or more of the reference areas may be moved during manufacturing, for example to optimize the location for each layer of build material, and camera pixels automatically remapped to the new location in real time based on the mapping transform.

Machine 10 in FIGS. 1 and 2 is just one example of an additive manufacturing machine that may be used to implement calibration and control processes and machine components. Other suitable machine components and configurations are possible.

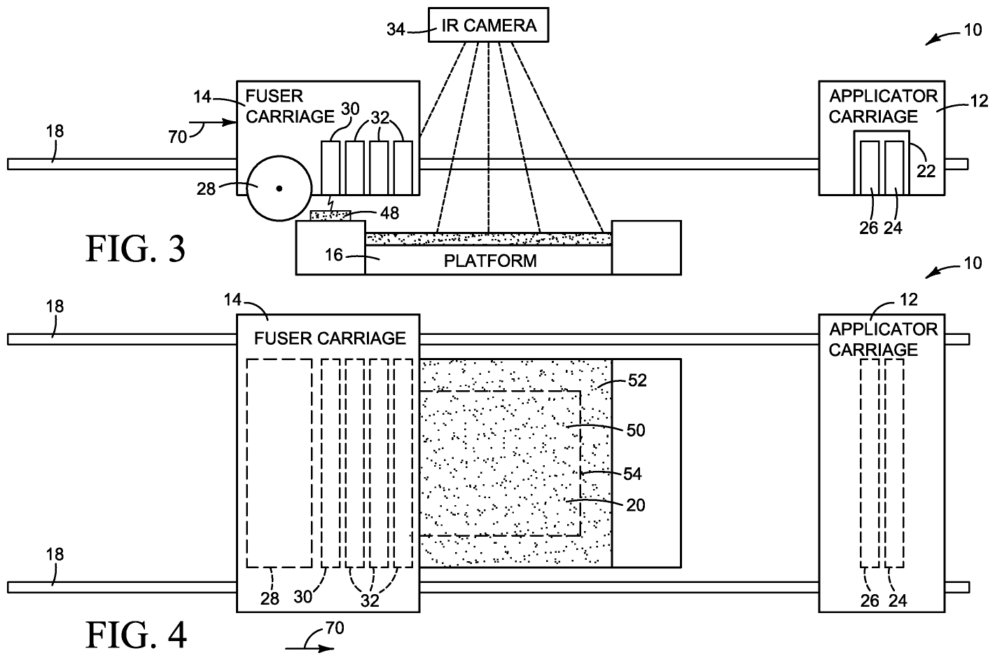

Referring now to the sequence of views shown in FIGS. 3-20, in FIGS. 3 and 4, a ribbon 48 of unfused build material has been dispensed adjacent to platform 16, heating lamp 30 is on to heat build material in ribbon 48, and roller 28 is deployed in preparation for spreading the next layer. In the example shown in FIGS. 3-20, camera 34 is implemented as a fixed overhead camera that is on throughout the calibration and build sequence. Other configurations are possible. For one example, camera 34 may be turned on and off at the desired times during calibration and fusing. For another example, camera 34 may be mounted to one of the carriages 12, 14 to scan back and forth over platform 16.

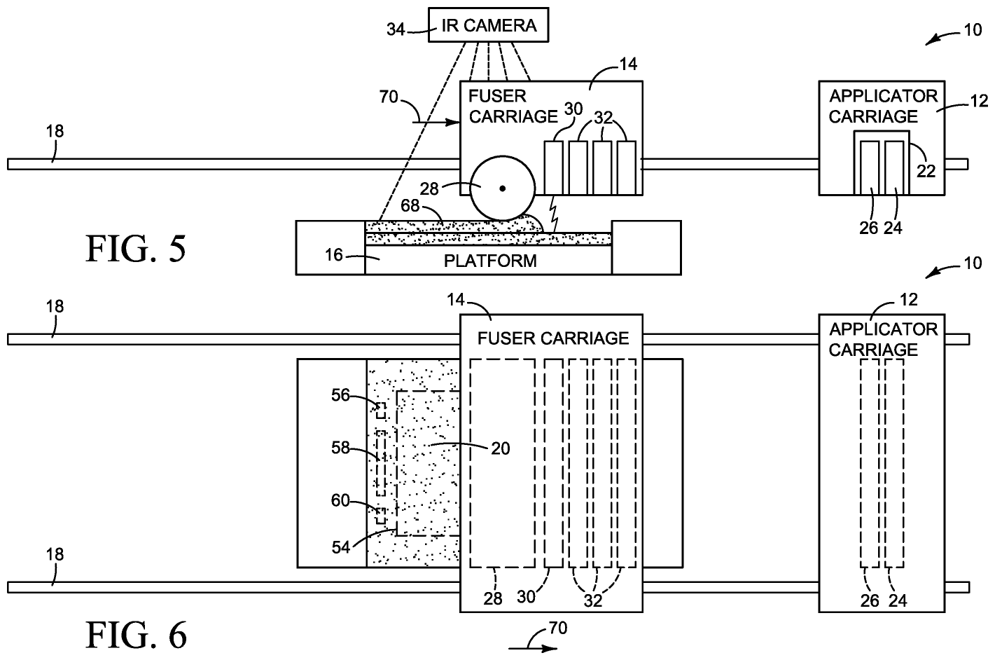

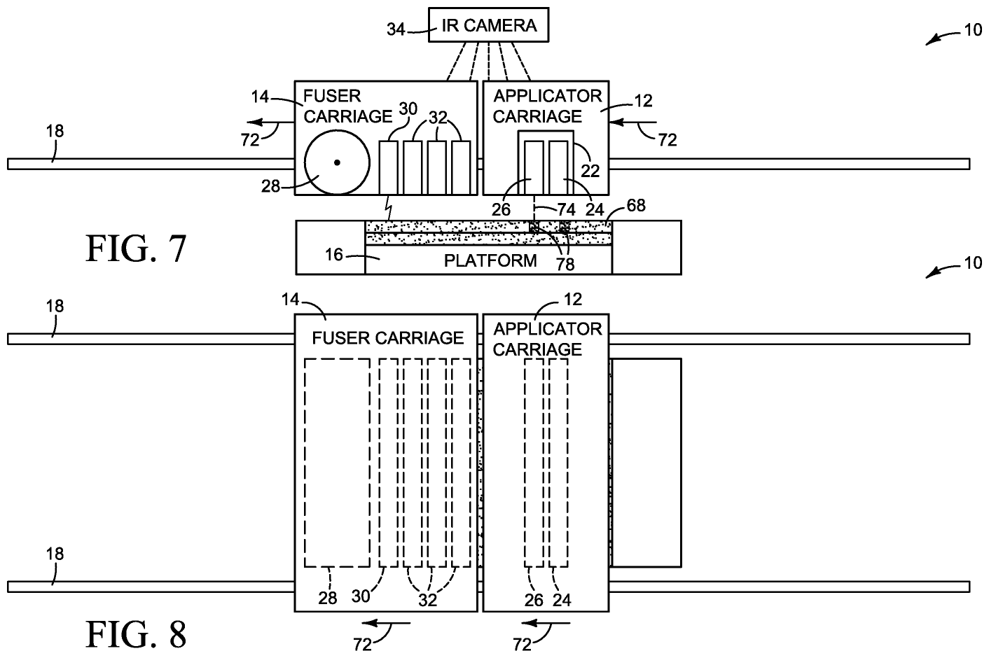

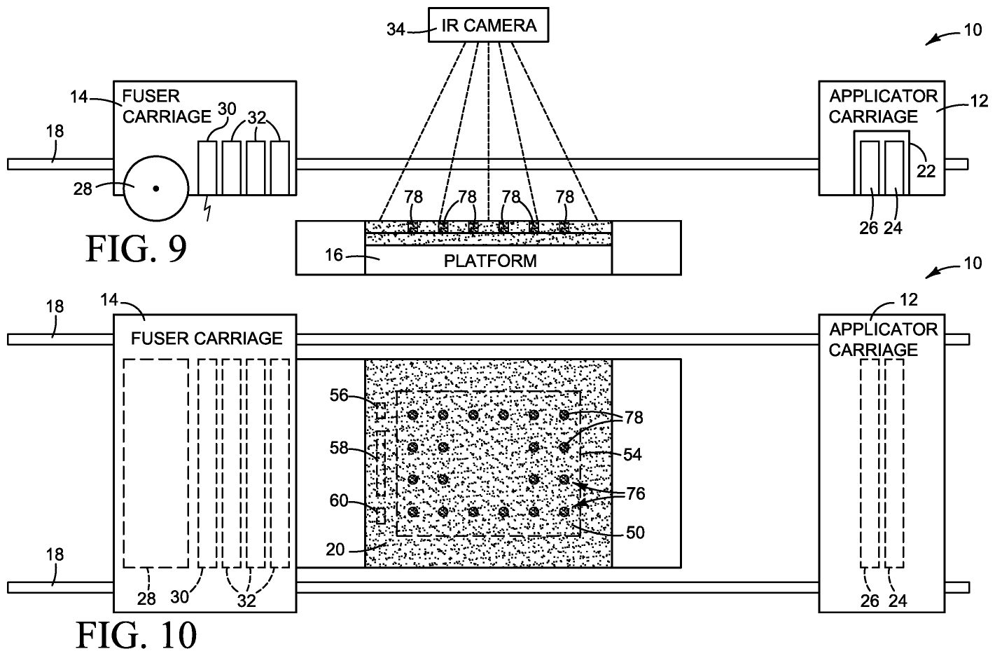

In FIGS. 5 and 6, a next layer 68 of unfused build material 20 is layered on to platform 16 over the prior layer(s) as fuser carriage 14 moves to the right, as indicated by direction arrow 70. In FIGS. 7 and 8, fuser carriage 14 is moving back over platform 16 as indicated by direction arrows 72, with heating lamp 30 on and roller 28 retracted. Applicator carriage 12 follows fuser carriage 14 over platform 16 with applicator 26 applying a coolant 74 to unfused build material 20 in layer 68 in a pattern 76 (FIG. 10) of spots 78 within build area 50. In FIGS. 9 and 10, spots 78 in pattern 76 are complete and each carriage 12, 14 is parked to the side of platform 16. Coolant 74 cools heated unfused build material 20 at each spot 78. Any suitable coolant may be used including, for example, a water based detailing agent. In this example, a detailing agent applied by applicator 26 is used as the coolant. In additive manufacturing processes that do not use a detailing agent, or the detailing agent is not a coolant, then another source of coolant may be used.

Infrared camera 34 captures an image of the spotted build material in layer 68. Each spot 78 is sensed by camera 34 as a cool spot on a warm background. Controller 36 uses the thermal image to map the pixel location in the thermal image representing each of multiple spots 78 in pattern 76 to the physical location of the spot on build platform 16 to establish a transform between camera pixels and physical locations on build platform 16. The transform can then be used to accurately map any physical location on platform 16 to the corresponding pixel or pixels of camera 34, including each reference area 56-60, to measure the temperature of build material at that location. Some or all of spots 78 in pattern 76 may be used to establish the mapping transform. Depending on the resolution of camera 34 and the size of each spot 78, each spot may cover more than one pixel location and thus more than one camera pixel. Pattern 76 is just one example of a suitable calibration pattern. Other suitable patterns are possible.

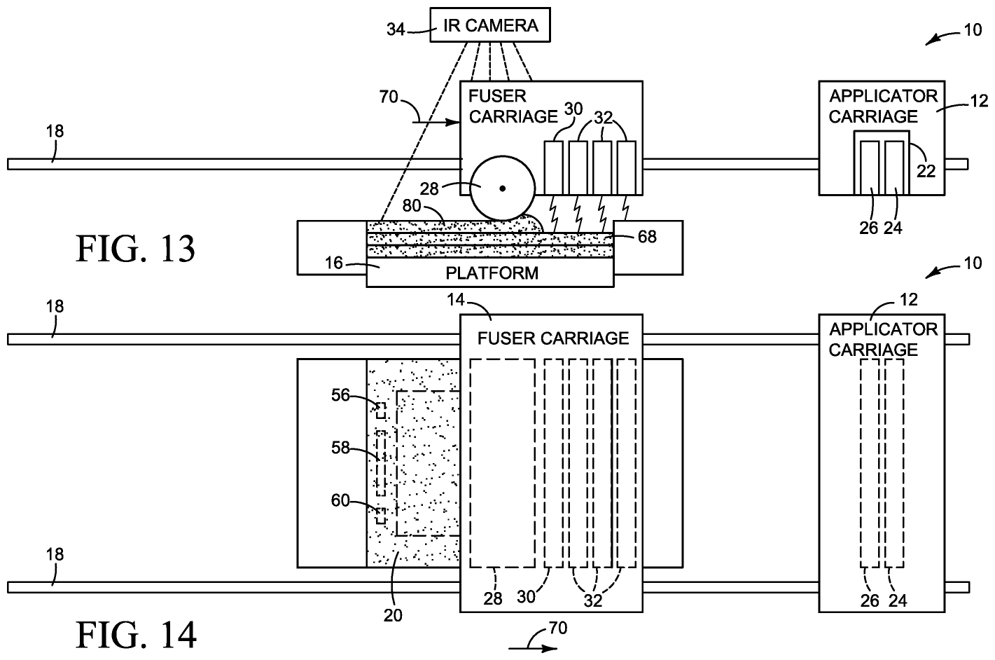

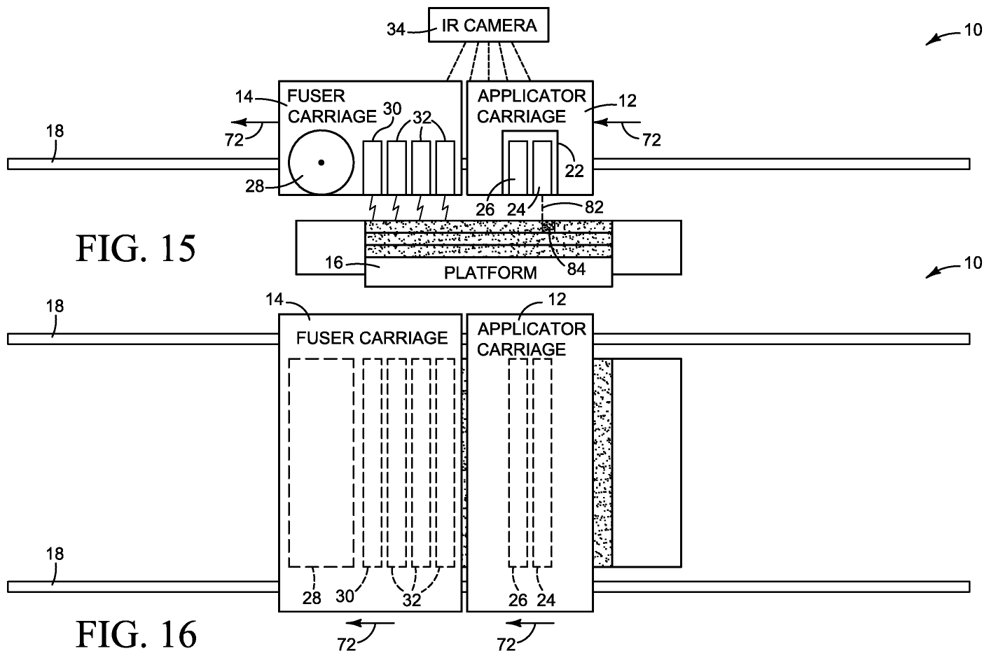

In FIGS. 11 and 12, a ribbon 48 of unfused build material 20 has been dispensed adjacent to platform 16, heating lamp 30 and fusing lamps 32 are on, and roller 28 is deployed in preparation for spreading the next layer. The coolant used to form spots 78 usually will evaporate quickly from the heated build material and, accordingly, spots 78 are not shown in build material layer 68 in FIGS. 11-20. In FIGS. 13 and 14, a next layer 80 of unfused build material 20 is layered on to platform 16 over layer 68 as fuser carriage 14 moves to the right. In FIGS. 15 and 16, fuser carriage 14 is moving to the left back over platform 16. Applicator carriage 12 follows fuser carriage 14 over platform 16 with fusing applicator 24 applying a fusing agent 82 in build area 50 in a pattern corresponding to a slice of one or multiple objects and to first and third reference areas 56, 60.

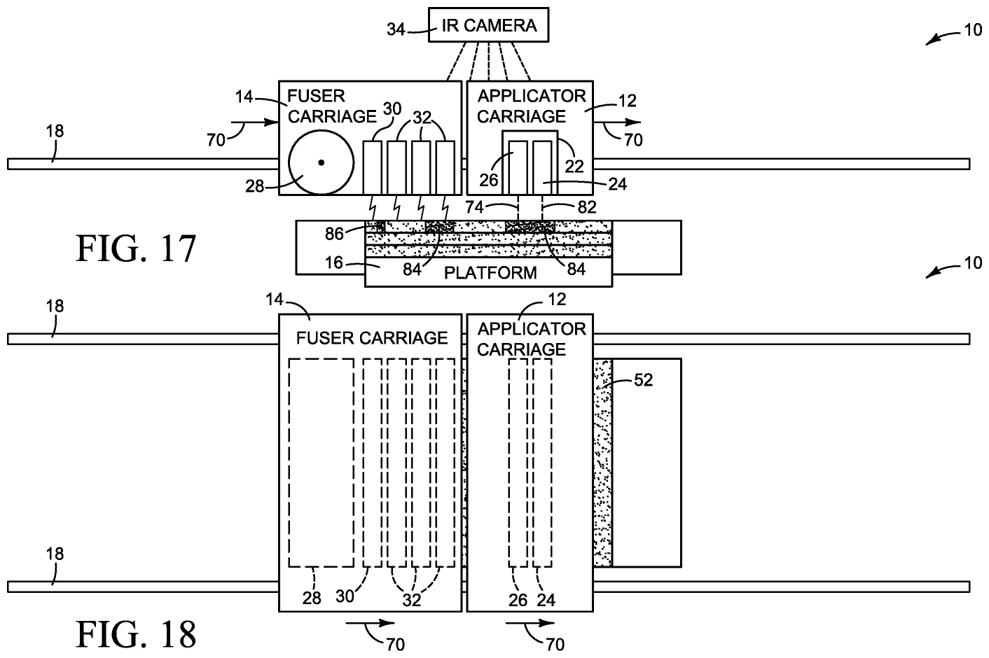

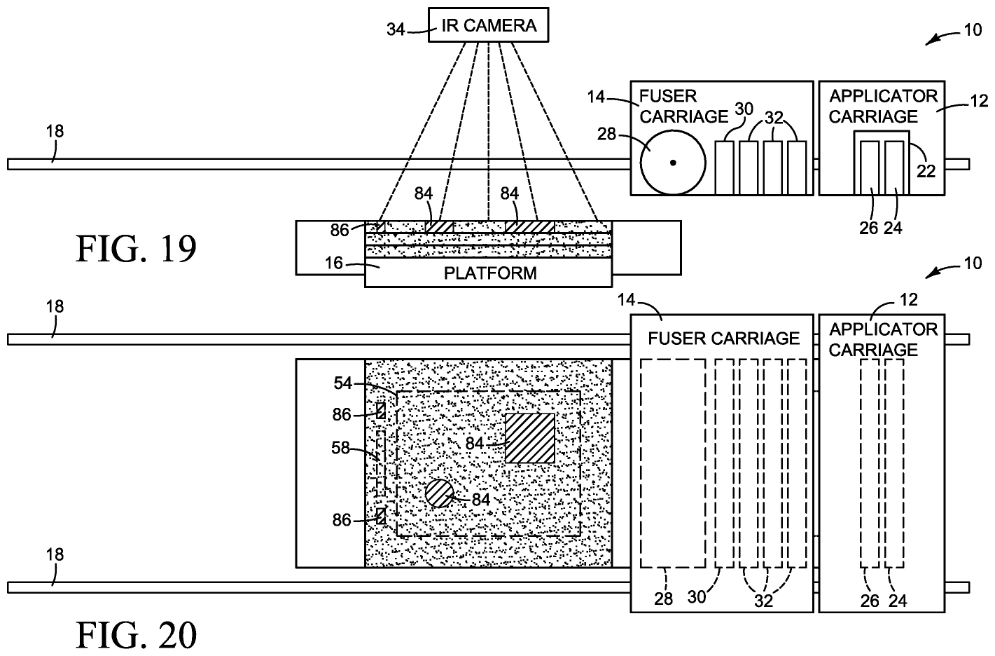

In FIGS. 17 and 18, carriages 12, 14 are moving to the right over platform 16 with applicators 24, 26 applying fusing and detailing agents 82, 74 and fusing lamps 32 applying energy to fuse patterned build material to form primary object layers 84 and to form reference object layers 86, as shown in FIGS. 19 and 20. Areas treated with fusing agent are depicted by dense stippling in FIGS. 15 and 17. Fused build material is depicted by hatching in FIGS. 19 and 20.

The sequence of FIGS. 11-20 is repeated for each object slice and corresponding layer to complete manufacturing of each primary object in build area 50 and each reference object in reference areas 56 and 60. The unfused build material in second reference area 58 is not treated by a fusing agent or a detailing agent. Controller 36 (FIGS. 1 and 21) uses temperature measurements from infrared camera 36 of fused material in reference areas 56, 60 to control the amount of fusing energy applied by fusing lamps 32. Controller 36 may also use temperature measurements from camera 36 of unfused build material in second reference area 58 to control the amount of heat applied to unfused build material by heating lamp 30. Fusing energy and heating adjustments may be made in real time during manufacturing, for example for each object layer or for each carriage pass for each object layer.

FIGS. 11-20 illustrate just one example build sequence. Other suitable build sequences are possible, including the application of more or different agents for fusing, detailing and coloring for example.

FIG. 22 is a flow diagram illustrating one example of a process for calibrating an infrared camera or other thermal imaging device to the build platform in an additive manufacturing machine, such as machine 10 shown in FIGS. 1-20. The process shown in FIG. 22 may be implemented, for example, by executing camera calibration instructions 40 on controller 36 in FIG. 21. Referring to FIG. 22, a calibration process 100 includes forming an extent of heated unfused build material on a support (block 102), for example by spreading layer 68 on platform 16 as shown in FIGS. 3-6, and then applying a coolant to unfused build material within the extent of unfused build material in a pattern of spots (block 104), for example by applying a detailing agent 74 on to layer 68 as shown in FIGS. 7-10. Process 100 also includes capturing a thermal image of the extent of unfused build material with a thermal imaging device (block 106), for example using an infrared camera 34 to photograph spots 78 in pattern 76 as shown in FIGS. 9 and 10, mapping a pixel location in the thermal image to a physical location for each of multiple spots in the pattern (block 108), and, based on the mapping, establishing a transform between pixels on the thermal imaging device and physical locations on the support (110).

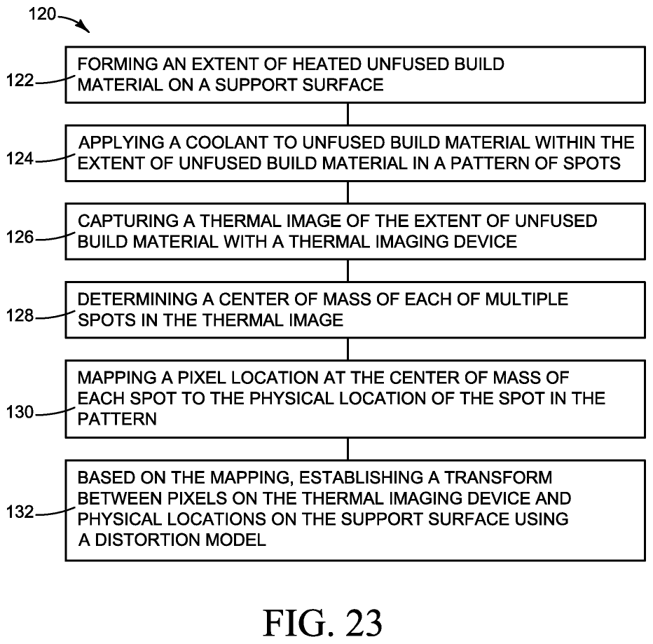

FIG. 23 is a flow diagram illustrating another example of a process for calibrating an infrared camera or other thermal imaging device to the build platform in an additive manufacturing machine, such as machine 10 shown in FIGS. 1-20. The process shown in FIG. 23 may be implemented, for example, by executing camera calibration instructions 40 on controller 36 in FIG. 21. Referring to FIG. 23, a calibration process 120 includes forming an extent of heated unfused build material on a support (block 122) and then applying a coolant to unfused build material within the extent of unfused build material in a pattern of spots (block 124). Process 100 also includes capturing a thermal image of the extent of unfused build material with a thermal imaging device (block 126), determining a center of mass of each of multiple spots in the thermal image (block 128), mapping a pixel location at the center of mass of each spot to the physical location of the spot in the pattern (block 130), and, based on the mapping, establishing a transform between pixels on the thermal imaging device and physical locations on the support using an openCV or other suitable distortion model (block 132).

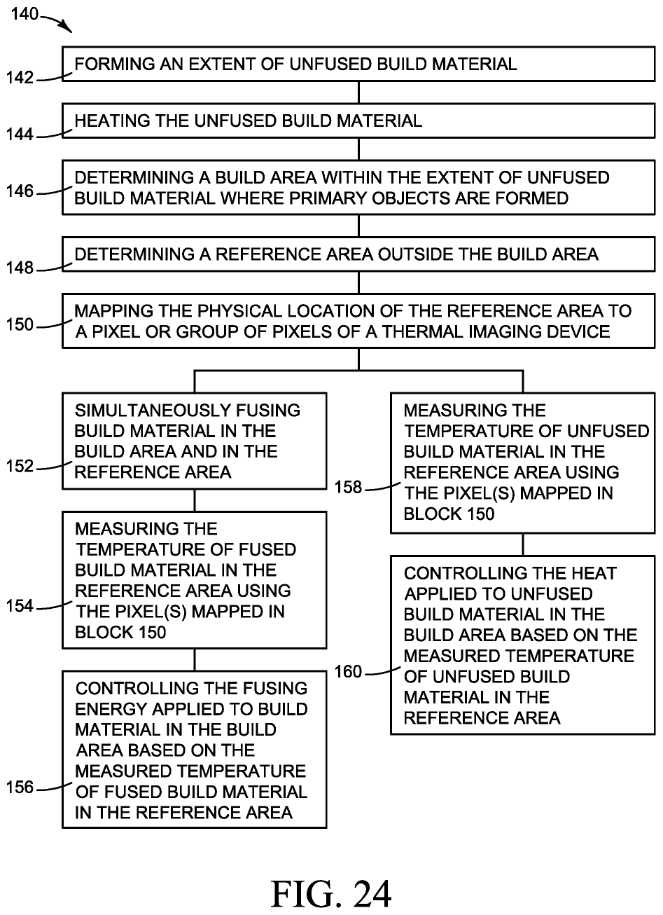

Once a transform is established using a calibration process such as that shown in FIG. 22 and FIG. 23, temperatures measured by the thermal imaging device may be used to control manufacturing parameters. FIG. 24 is a flow diagram illustrating one example of a control process for additive manufacturing using temperatures measured by a thermal imaging device that has been calibrated to the build platform as described above. Referring to FIG. 24, a control process 140 includes forming an extent of unfused build material (block 142) and heating the unfused build material (block 144), for example by heating and spreading build material 20 in a next layer 80 as shown in FIGS. 11-14. Unfused build material may be heated before, during and/or after forming the extent of unfused build material. Process 140 also includes determining a build area within the extent of unfused build material (block 146) where primary objects are formed and a reference area outside the build area (block 148), for example build area 50 and reference areas 56-60 in FIG. 2, and mapping the physical location of the reference area to a pixel or group of pixels of the thermal imaging device (block 150).

In one example, control process 140 includes simultaneously fusing build material in the build area and in the reference area (block 152), measuring the temperature of fused build material in the reference area using the pixel(s) mapped in block 150 (block 154), and controlling the fusing energy applied to build material in the build area based on the measured temperature of fused build material in the reference area (block 156). In another example, control process 140 includes measuring the temperature of unfused build material in the reference area using the pixel(s) mapped in block 150 (block 158) and controlling the heat applied to unfused build material in the build area based on the measured temperature of unfused build material in the reference area (block 160).

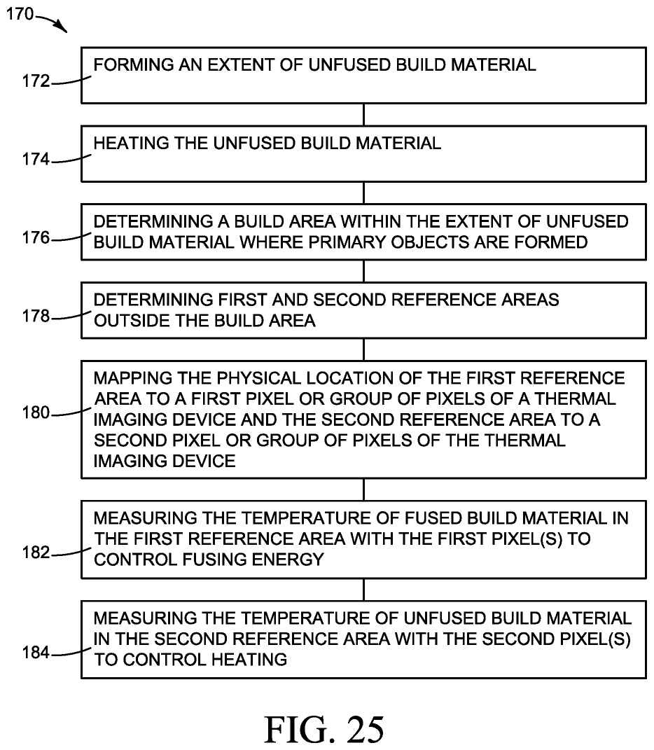

FIG. 25 is a flow diagram illustrating another example of a control process for additive manufacturing using temperatures measured by a thermal imaging device that has been calibrated to the build platform as described above. Referring to FIG. 25, a control process 170 includes forming an extent of unfused build material (block 172), heating the unfused build material (block 174), determining a build area within the extent of unfused build material where primary objects are formed (block 176) and determining first and second references areas outside the build area (block 178). Process 170 also includes mapping first and second pixels (or groups of pixels) of the thermal imaging device to the first and second reference areas respectively (block 180), measuring the temperature of fused build material in the first reference area with the first pixel(s) to control fusing energy (block 182) and measuring the temperature of unfused build material in the second reference area with the second pixel(s) to control heating (block 184).

The extent of unfused build material may be determined by the structural limits of a build platform or other structure that contains the build material during manufacturing. While it is expected that usually the build area will be determined by a set of fixed physical coordinates that do not change during manufacturing, it may be desirable (and possible) in some additive manufacturing machines to adjust the size and/or position of the build area during or between build cycles. The reference area may also be determined by a set of fixed physical coordinates near the perimeter of the build area, or the reference area(s) may be determined dynamically with respect to a changing build area.

Although the temperature of both fused and unfused build material may be measured in a single reference area, it is expected that separate, non-contiguous reference areas such as areas 56-60 in FIG. 1 usually will be desirable to measure the temperature of fused and unfused material for more consistent and accurate measurements. Separate reference areas facilitate mapping the physical location of the fused and unfused reference areas to distinct groups of camera pixels. Separate reference areas also reduce the risk of unfused build material adversely affecting the temperature measurements of fused build material, and vice versa.

In an example, an additive manufacturing machine includes: a surface to support a succession of layers of build material; a build area within a perimeter of the support; a first reference area within the perimeter of the support outside the build area; a layering device to layer unfused build material on to the support in the build area and in the first reference area; a heater to heat build material on the support; an applicator to selectively apply a fusing agent to heated build material on the support; a source of fusing energy to irradiate build material on the support to which a fusing agent has been applied; and a thermal imaging device having a first pixel mapped to the first reference area to measure a temperature of fused build material in the first reference area or to measure a temperature of unfused build material in the first reference area.

In one example, the controller is programmed to calibrate the thermal imaging device to the support surface before mapping the physical location of the first reference area to the first pixel.

In one example, the controller is programmed for calibration to: form an extent of unfused build material on the support surface; apply a coolant to unfused build material within the extent of unfused build material in a pattern of spots; capture a thermal image of the extent of unfused build material; map a pixel location in the thermal image to a physical location for each of multiple spots in the pattern; and based on the mapping, establish a transform between pixels on the thermal imaging device and physical locations on the support surface; and where the first pixel of the thermal imaging device is mapped to the first reference area according to the transform.

In one example, the additive manufacturing machine includes a second reference area within the perimeter of the support surface outside the build area and where: the thermal imaging device is to measure the temperature of fused build material in the first reference area; and the thermal imaging device has a second pixel mapped to the second reference area to measure a temperature of unfused build material in the second reference area. In this example, the controller may be programmed to: control the layering device to form an extent of unfused build material on the support surface; determine the first reference area within the extent of unfused build material outside the build area where the temperature of fused build material is the same as a temperature of fused build material inside the build area during manufacturing; determine the second reference area within the extent of unfused build material outside the build area where the temperature of unfused build material is the same as a temperature of unfused build material inside the build area during manufacturing; and then control the applicator to apply a fusing agent to build material in the build area; control the energy source to irradiate build material in the build area based on the temperature of fused build material in the first reference area measured by the first pixel of the thermal imaging device; and control the heat source to heat unfused build material in the build area based on the temperature of unfused build material in the second reference area measured by the second pixel of the thermal imaging device.

In an example, a memory includes instructions that when executed cause an additive manufacturing machine to: form an extent of unfused build material on a support; determine a build area within the extent of unfused build material; determine a first reference area within the extent of unfused build material outside the build area where a temperature of fused build material is the same as a temperature of fused build material inside the build area during manufacturing; map a physical location of the first reference area to a first pixel of a thermal imaging device; fuse build material in the build area; fuse build material in the first reference area while fusing build material in the build area; measure a temperature of fused build material in the first reference area with the first pixel; and control fusing energy applied to build material in the build area based on the measured temperature of fused build material in the first reference area.

In one example, the memory includes instructions to: heat the unfused build material; determine a second reference area within the extent of unfused build material outside the build area where a temperature of unfused build material is the same as a temperature of unfused build material inside the build area during manufacturing; map a physical location of the second reference area to a second pixel of the thermal imaging device; measure a temperature of fused build material in the first reference area with the second pixel; and control heat applied to the unfused build material based on the measured temperature of unfused build material in the second reference area.

In one example, the memory includes instructions to calibrate the thermal imaging device to the support before mapping the physical location of the first reference area to a first pixel of the thermal imaging device. In one example, the calibration instructions includes to: apply a coolant to unfused build material within the extent of unfused build material in a pattern of spots; capture a thermal image of the extent of unfused build material with the thermal imaging device; map a pixel location in the thermal image to a physical location for each of multiple spots in the pattern; and based on the mapping, establish a transform between pixels on the thermal imaging device and physical locations on the support; and where the instructions to map a physical location of the first reference area to a first pixel of the thermal imaging device includes instructions to map a physical location of the first reference area to a first pixel of the thermal imaging device according to the transform.

As noted at the beginning of this Description, the examples shown in the figures and described above illustrate but do not limit the scope of the patent. Other examples are possible. Therefore, the foregoing description should not be construed to limit the scope of the patent, which is defined in the following Claims.

“A” and “an” as used in the Claims means one or more. For example, “a pixel” means one or more pixels and subsequent reference to “the pixel” means the one or more pixels.

1. A control process for additive manufacturing, comprising:
forming an extent of unfused build material on a support;
applying a coolant to unfused build material within the extent of unfused build material in a pattern of spots;
capturing a thermal image of the extent of unfused build material with a thermal imaging device;
mapping a pixel location in the thermal image to a physical location for each of multiple spots in the pattern; and
based on the mapping, establishing a transform between pixels on the thermal imaging device and physical locations on the support.

2. The process of claim 1, comprising determining a center of mass of each of multiple spots in the thermal image and where the mapping includes mapping a pixel location at the center of mass of each spot to the physical location of the spot in the pattern.

3. The process of claim 2, where the establishing includes establishing a transform between pixels on the thermal imaging device and physical locations on the support using a distortion model.

4. The process of claim 1, comprising:
determining a build area within the extent of unfused build material;
determining a reference area within the extent of unfused build material outside the build area;
mapping a physical location of the reference area to a pixel of the thermal imaging device according to the transform; and then
fusing build material in the build area;
fusing build material in the reference area while fusing build material in the build area;
measuring a temperature of fused build material in the reference area with the pixel; and
controlling fusing energy applied to build material in the build area based on the measured temperature of fused build material in the reference area.

5. The process of claim 1, comprising:
determining a build area within the extent of unfused build material;
determining a reference area within the extent of unfused build material outside the build area;
mapping a physical location of the reference area to a pixel of the thermal imaging device according to the transform; and then
measuring a temperature of unfused build material in the reference area; and
controlling heat applied to unfused build material in the build area based on the measured temperature of unfused build material in the reference area.

6. The process of claim 5, comprising:
determining a build area within the extent of unfused build material;
determining a first reference area within the extent of unfused build material outside the build area;
determining a second reference area within the extent of unfused build material outside the build area;
mapping a physical location of the first reference area to a first pixel of the thermal imaging device according to the transform;
mapping a physical location of the second reference area to a second pixel of the thermal imaging device according to the transform; and then
fusing build material in the build area;
fusing build material in the first reference area while fusing build material in the build area;
measuring a temperature of fused build material in the first reference area with the first pixel;
controlling fusing energy applied to build material in the build area based on the measured temperature of fused build material in the first reference area
measuring a temperature of unfused build material in the second reference area with the second pixel; and
controlling heat applied to unfused build material in the build area based on the measured temperature of unfused build material in the second reference area.

7. An additive manufacturing machine, comprising:
a layering device to layer unfused build material on to a support;
a heater to heat build material on the support;
an applicator to selectively apply a fusing agent and a coolant to heated build material on the support;
a source of fusing energy to irradiate build material on the support to which a fusing agent has been applied;
a thermal imaging device having a first pixel mapped to a first reference area within a perimeter of the support to measure a temperature of fused build material in the first reference area and/or to measure a temperature of unfused build material in the first reference area; and
a controller programmed to calibrate the thermal imaging device to the support and then map the physical location of the first reference area to the first pixel.

8. The machine of claim 7, where the controller is programmed for calibration to:
form an extent of unfused build material on the support;
apply a coolant to unfused build material within the extent of unfused build material in a pattern of spots;
capture a thermal image of the extent of unfused build material;
map a pixel location in the thermal image to a physical location for each of multiple spots in the pattern; and
based on the mapping, establish a transform between pixels on the thermal imaging device and physical locations on the support; and where
the first pixel of the thermal imaging device is mapped to the first reference area according to the transform.

9. The machine of claim 7, where:
the thermal imaging device is to measure the temperature of fused build material in the first reference area;
the thermal imaging device has a second pixel mapped to a second reference area within a perimeter of the support to measure a temperature of unfused build material in the second reference area; and
the controller is programmed to, after calibrating the thermal imaging device to the support, map the physical location of the second reference area to the first pixel.

10. The machine of claim 9, where the controller is programmed to:
control the layering device to form an extent of unfused build material on the support;
determine the first reference area within the extent of unfused build material outside a build area where the temperature of fused build material corresponds to a temperature of fused build material inside the build area during manufacturing;
determine the second reference area within the extent of unfused build material outside the build area where the temperature of unfused build material corresponds to a temperature of unfused build material inside the build area during manufacturing; and then
control the applicator to apply a fusing agent to build material in the build area;
control the energy source to irradiate build material in the build area based on the temperature of fused build material in the first reference area measured by the first pixel of the thermal imaging device; and
control the heat source to heat unfused build material in the build area based on the temperature of unfused build material in the second reference area measured by the second pixel of the thermal imaging device.

11. A memory having instructions thereon that when executed cause an additive manufacturing machine to:
form an extent of unfused build material on a support;
apply a coolant to unfused build material within the extent of unfused build material in a pattern of spots;
capture a thermal image of the extent of unfused build material with a thermal imaging device;
map a pixel location in the thermal image to a physical location for each of multiple spots in the pattern; and
based on the mapping, establish a transform between pixels on the thermal imaging device and physical locations on the support.

12. The memory of claim 11 having instructions thereon to determine a center of mass of each of multiple spots in the thermal image and where the instructions to map a pixel location include instructions to map a pixel location at the center of mass of each spot to the physical location of the spot in the pattern.

13. The memory of claim 12, where the instructions to establish a transform includes instructions to establish a transform between pixels on the thermal imaging device and physical locations on the support using a distortion model.

14. The memory of claim 11 having instructions thereon to:
determine a build area within the extent of unfused build material;
determine a reference area within the extent of unfused build material outside the build area;
map a physical location of the reference area to a pixel of the thermal imaging device according to the transform; and then
fuse build material in the build area;
fuse build material in the reference area while fusing build material in the build area;
measure a temperature of fused build material in the reference area with the pixel; and
control fusing energy applied to build material in the build area based on the measured temperature of fused build material in the reference area.
